(19) United States
(12) Patent Application Publication
(10) Pub. No.: US 2022/0241796 A1
(43) Pub. Date: Aug. 4, 2022

(54) CONCRETE SLUDGE RECYCLING AND RECOVERING METHOD

(71) Applicant: VICAT, L'Isle-D'Abeau (FR)

(72) Inventors: Olivier TOSONI, VIENNE (FR); Hervé GUILLEMIN, Sermerieu (FR); Rémi DEL MEDICO, Engins (FR); Stéphane ROUX, Corbelin (FR); David LETELLIER, Lyon (FR)

(21) Appl. No.: 17/607,715

(22) PCT Filed: Apr. 22, 2020
(86) PCT No.: PCT/EP2020/061127

§ 371 Date: Oct. 29, 2021

(30) Foreign Application Priority Data
Apr. 30, 2019 (FR) 19/04553

(51) Int. Cl. B03B 9/06

(52) U.S. Cl. CPC B03B 9/063

(57) ABSTRACT

The concrete sludge recycling and recovering method comprises a concrete sludge treatment step consisting in separating aggregates, contained in the concrete sludge, from the water loaded with laitance contained in the concrete sludge; a clarification and dewatering step consisting in clarifying the water loaded with laitance which has been separated during the concrete sludge treatment step and dewatering the laitance contained in the water loaded with laitance; a first use step consisting in using the separated aggregates as raw material for concrete manufacturing; and a second use step consisting in using at least part of the clarified water resulting from the clarification and dewatering step as a raw material for concrete manufacturing.

### CROSS REFERENCE TO RELATED APPLICATIONS

This application is a National Stage of PCT Application No. PCT/EP2020/061127 filed on Apr. 22, 2020, which claims priority to French Patent Application No. 19/04553 filed on Apr. 30, 2019, the contents each of which are incorporated herein by reference thereto.

### TECHNICAL FIELD

The present invention concerns a method for recycling and recovering concrete sludge, and more particularly concrete sludge originating from concrete manufacturing plants.

### BACKGROUND

A concrete manufacturing plant, also known as a concrete plant, is designed to produce concrete in very large amounts, and includes in particular a mixing device configured to mix the different materials constituting the concrete to be produced. Concrete produced in the mixing device is generally transported to a construction site using a mixer truck, also known as a truck mixer.

In order to prevent clogging of the mixing device of the concrete manufacturing plant, a regular washing of the mixing device is required. Similarly, it is also required to carry out regular washing of the rotary tanks of the mixer trucks.

For environmental reasons, the washing water resulting from washing of a concrete manufacturing plant and of mixer trucks should be recycled. In general, this washing water is conveyed to a decantation basin in which the aggregates and laitance contained in the washing water fall by gravity to the bottom of the decantation basin.

The concrete sludge formed by these decantated aggregates and laitance is then scraped out and stored in a storage tank, such as a storage container or a storage pit, of the concrete manufacturing plant. Concrete returns from mixer trucks and defective or unsold concrete that has been manufactured by the concrete manufacturing plant are also stored in such a storage tank.

Periodically or non-periodically, the content of the storage tank is evacuated to a waste storage center, such as a quarry or an engineered landfill site, where they are buried in the ground.

However, such a concrete manufacturing plant has many drawbacks.

A first drawback of such a concrete manufacturing plant lies in the fact that a very large decantation basin may be required if the production of the concrete manufacturing plant is high. Yet, the surface area of a concrete manufacturing plant does not always allow the construction of a very large decantation basin.

A second drawback of such a concrete manufacturing plant lies in the fact that the use of a decantation basin to treat the washing water can induce a spillover of the decantation basin in the event of heavy rainfall, and therefore a partial flooding of the concrete manufacturing plant. Yet, such flooding might be detrimental to the effective operation of the concrete manufacturing plant.

A third drawback of such a concrete plant manufacturing lies in the fact that the costs of transporting concrete sludge to a waste storage center and of burying concrete sludge in the waste storage center are relatively high.

### BRIEF SUMMARY

The present invention aims at overcoming all or part of these drawbacks.

The technical problem underlying the invention consists therefore in providing a method for recycling and recovering concrete sludge which is economic and ecological, while ensuring optimum recovering of concrete sludge.

To this end, the present invention concerns a method for recycling and recovering concrete sludge, and preferably concrete sludge from at least one concrete manufacturing plant, comprising the following steps:
a concrete sludge treatment step consisting in separating the aggregates contained in the concrete sludge from the water loaded with laitance contained in the concrete sludge,
a clarification and dewatering step consisting in clarifying the water loaded with laitance which has been separated during the concrete sludge treatment step and in dewatering the laitance contained in the water loaded with laitance which has been separated during the concrete sludge treatment step,
a first use step consisting in using the separated aggregates as a raw material for concrete manufacturing, and
a second use step consisting in using at least part of the clarified water resulting from the clarification and dewatering step as a raw material for concrete manufacturing.

In the present document, by “concrete sludge” it should be understood in particular the washing water resulting from washing mixing devices of concrete manufacturing plants, the concrete returns from the mixer trucks, the washing water resulting from washing the rotating tanks and the chutes of the mixer trucks, the content of the storage tanks intended to store the concrete returns from the concrete manufacturing plants, the defective or unsold concretes which have been manufactured by the concrete manufacturing plants, the solidified concretes which have been scraped out in decantation basins of concrete manufacturing plants.

Such a configuration of the recycling and recovering method according to the present invention makes it possible to separate the aggregates contained in the concrete sludge and to use them again for concrete manufacturing.

Thus, the treatment of concrete sludge according to the present recycling and recovering method considerably reduces the amount of material to be buried in the ground, and therefore the operating costs of a concrete manufacturing plant, and makes it possible to recover this concrete sludge.

In addition, the fact of using at least part of the clarified water resulting from the clarification and dewatering step as a raw material for concrete manufacturing makes it possible to recycle and recover a significant part of the washing water.

The recycling and recovering method may also have one or more of the following features, considered alone or in combination.

According to an implementation of the recycling and recovering method, the latter comprises a third use step consisting in using the dewatered laitance as a raw material for cement manufacturing. Such a configuration of the recycling and recovering method according to the present invention makes it possible, on the one hand, to further reduce the amount of material to be transferred to the conventional recycling industry, and therefore the operating costs of a concrete manufacturing plant, and on the other hand to further recover the concrete sludge.

According to another implementation of the recycling and recovering method, the latter comprises an evacuation step consisting in evacuating the dewatered laitance to a waste storage center, such as a quarry or an engineered landfill site.

According to another implementation of the recycling and recovering method, the concrete sludge treatment step includes a first separation step consisting in separating coarse aggregates, contained in the concrete sludge and having dimensions larger than a first predetermined value, from water loaded with laitance and with fine aggregates which is contained in the concrete sludge, and a second separation step consisting in separating fine aggregates, contained in the water loaded with laitance and with fine aggregates which has been separated during the first separation step and having dimensions larger than a second predetermined value, from water loaded with laitance, the second predetermined value being lower than the first predetermined value. These two successive separation steps ensure an optimum separation of the coarse aggregates and fine aggregates contained in the concrete sludge. The coarse aggregates and the separated fine aggregates may be used for the production of any type of concrete, including visible concrete.

According to an implementation of the recycling and recovering method, the first use step consists in using the coarse aggregates and the separated fine aggregates as a raw material for concrete manufacturing.

According to an implementation of the recycling and recovering method, the first predetermined value is comprised between 300 and 700 μm, and advantageously between 400 and 600 μm, and is for example equal to approximately 500 μm.

According to an implementation of the recycling and recovering method, the second predetermined value is comprised between 60 and 100 μm, and advantageously between 70 and 90 μm, and is for example equal to approximately 80 μm.

According to an implementation of the recycling and recovering method, the first separation step comprises a step of washing the concrete sludge.

According to an implementation of the recycling and recovering method, the concrete sludge washing step is carried out with clarified water resulting from the clarification and dewatering step.

According to another implementation of the recycling and recovering method, the concrete sludge washing step is carried out with water loaded with laitance which has been separated during the concrete sludge treatment step, and for example with water loaded with laitance resulting from the second separation step.

According to an implementation of the recycling and recovering method, the first separation step is carried out using a concrete recycler.

According to an implementation of the recycling and recovering method, the first separation step comprises an introduction step consisting in introducing concrete sludge into an inner tank of the concrete recycler via an introduction hopper of the concrete recycler, a first evacuation step consisting in evacuating the water loaded with laitance and fine aggregates out of the concrete recycler and a second evacuation step consisting in evacuating the coarse aggregates out of the concrete recycler.

According to an implementation of the recycling and recovering method, the concrete sludge washing step is carried out in the inner tank of the concrete recycler.

Advantageously, the concrete recycler is equipped with a water supply orifice which is fluidly connected to the inner tank.

According to an implementation of the recycling and recovering method, the coarse aggregates evacuated from the concrete recycler fall by gravity onto the ground or into a coarse aggregate storage receptacle.

According to an implementation of the recycling and recovering method, the second separation step is carried out at least partially by centrifugation.

According to an implementation of the recycling and recovering method, the second separation step comprises an introduction step consisting in introducing the water loaded with laitance and with fine aggregates, which has been separated during the first separation step, in a hydrocyclone, a first evacuation step consisting in evacuating the water loaded with laitance out of the hydrocyclone via an upper evacuation orifice provided in an upper portion of the hydrocyclone, a second evacuation step consisting in evacuating water loaded with fine aggregates out of the hydrocyclone via a lower evacuation orifice provided in a lower portion of the hydrocyclone, and a filtration step consisting in filtering the water loaded with fine aggregates so as to separate the fine aggregates from the water.

According to an implementation of the recycling and recovering method, the separated fine aggregates are received in a fine aggregate collecting receptacle.

According to an implementation of the recycling and recovering method, the filtration step is carried out with a vibrating grid.

According to an implementation of the recycling and recovering method, the clarification and dewatering step consists in decanting the water loaded with laitance which has been separated during the concrete sludge treatment step and in dewatering the decanted laitance.

According to an implementation of the recycling and recovering method, the clarification and dewatering step is carried out using a clarification and pressing device, such as a vertical decantation silo or a filter press. These arrangements make it possible to dispense with a decantation basin and therefore avoid the drawbacks associated with the use of a decantation basin.

According to an implementation of the recycling and recovering method, the vertical decantation silo includes a decantation chamber configured to be supplied with water loaded with laitance, and a pressing chamber located below the decantation chamber and configured to receive the decanted laitance, the laitance being dewatered in the pressing chamber by the pressure exerted by the water column contained in the decantation chamber. These arrangements limit the risks of failure of the clarification and pressing device.

According to an implementation of the recycling and recovering method, the pressing chamber is equipped with a water outlet pipe, and the recycling and recovering method comprises a step consisting in isolating the pressing chamber from the decantation chamber and placing a lower portion of the pressing chamber in communication with the exterior of the vertical decantation silo when the water flow rate through the water outlet pipe is lower than a predetermined flow rate value, so as to drop by gravity the dewatered laitance out of the vertical decantation silo.

According to an implementation of the recycling and recovering method, the vertical decantation silo includes an upper closing device comprising an upper closing element which is movable between a closed position in which the upper closing element isolates the decantation chamber from the pressing chamber and an open position in which the upper closing element fluidly communicates the decantation chamber and the pressing chamber, and a lower closing device comprising a lower closing element which is movable between a closed position in which the lower closing element isolates a lower portion of the pressing chamber from the outside of the vertical decantation silo and an open position in which the lower closing element allows an evacuation by gravity of the dewatered laitance out of the pressing chamber and the vertical decantation silo. Each of the upper and lower closing devices can for example be formed by a knife gate valve.

According to an implementation of the recycling and recovering method, the latter comprises a conveying step consisting in conveying, for example by gravity, the water loaded with laitance, which has been separated during the concrete sludge treatment step, in a stirring basin, and a stirring step consisting of stirring the water loaded with laitance contained in the stirring basin, the conveying and stirring steps being carried out prior to the clarification and dewatering step.

According to an implementation of the recycling and recovering method, the recycling and recovering method comprises a supply step consisting in supplying the clarification and pressing device with water loaded with laitance from the stirring basin.

According to an implementation of the recycling and recovering method, the latter comprises a storage step consisting in storing at least part of the clarified water resulting from the clarification and dewatering step in a storage basin.

According to an implementation of the recycling and recovering method, the latter comprises a mixer truck washing step consisting in washing mixer trucks with clarified water resulting from the clarification and dewatering step.

According to another implementation of the recycling and recovering method, the latter comprises a mixer truck washing step consisting in washing mixer trucks with water loaded with laitance resulting from the concrete sludge treatment step.

According to an implementation of the recycling and recovering method, the latter comprises a cleaning step consisting in cleaning at least one mixing device of a concrete manufacturing plant with clarified water resulting from the clarification and dewatering step.

According to an implementation of the recycling and recovering method, the latter further includes a concrete sludge screening step which is carried out prior to the concrete sludge treatment step and which consists in separating concrete blocks, which have dimensions larger than a predetermined dimension, from concrete sludge. Such a screening step avoids the introduction of large concrete blocks in the separation devices configured to separate the aggregates, and therefore limit the risks of clogging or breakage of these separation devices.

According to an implementation of the recycling and recovering method, the predetermined dimension is comprised between 10 and 30 mm, advantageously between 15 and 25 mm, and is for example equal to approximately 20 mm.

According to an implementation of the recycling and recovering method, the screening step is carried out using a screening bucket.

According to an implementation of the recycling and recovering method, the latter comprises a step of crushing the separated concrete blocks.

According to an implementation of the recycling and recovering method, the recycling and recovering method comprises a step of using crushed concrete blocks for the building construction, such as buildings, road infrastructure or urban developments of any type. These arrangements make it possible to further improve the recovering of concrete sludge.

According to an implementation of the recycling and recovering method, the latter includes a collection step consisting in collecting concrete sludge from different concrete manufacturing plants. These arrangements make it possible to centralize the treatment of concrete sludge in the same concrete manufacturing plant.

According to an implementation of the recycling and recovering method, the latter comprises a provision step consisting in providing a concrete manufacturing plant comprising a concrete sludge treatment unit configured to separate aggregates contained in concrete sludge from the water loaded with laitance contained in the concrete sludge, and a clarification and dewatering unit configured to clarify the water loaded with laitance which has been separated by the concrete sludge treatment unit and to dewater the laitance contained in the water loaded with laitance.

### BRIEF DESCRIPTION OF THE DRAWINGS

In any event, the invention will be clearly understood by means of the following description with reference to the appended schematic drawings representing, as a non-limiting example, an embodiment of a concrete manufacturing plant allowing the implementation of the recycling and recovering method according to the present invention.

FIG. 1 is a schematic view of a concrete manufacturing plant allowing the implementation of a recycling and recovering method according to the present invention.

### DETAILED DESCRIPTION

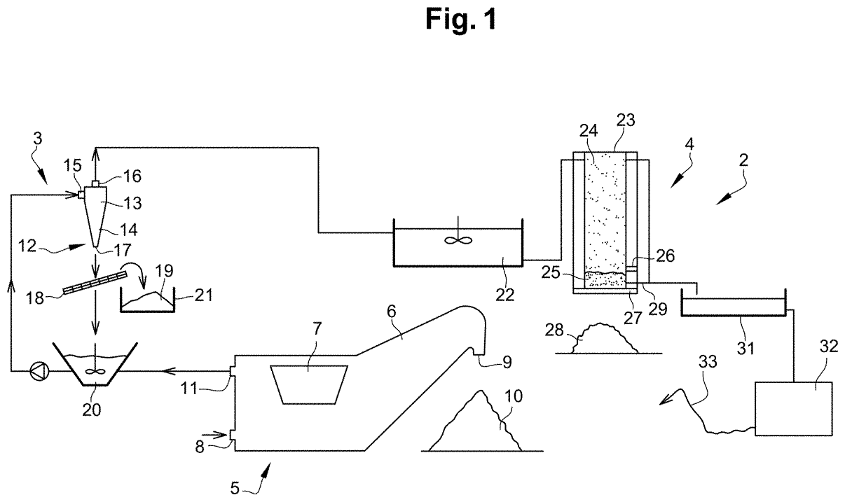

FIG. 1 represents a concrete manufacturing plant 2 comprising a concrete sludge treatment unit 3 configured to separate aggregates, contained in concrete sludge, from water loaded with laitance contained in concrete sludge, and a clarification and dewatering unit 4 configured to clarify the water loaded with laitance which has been separated by the concrete sludge treatment unit 3 and to dewater the laitance contained in the water loaded with laitance.

The concrete sludge treatment unit 3 more particularly includes a concrete recycler 5 including in particular an inner tank 6, an introduction hopper 7 opening into the inner tank 6 and configured for the introduction of concrete sludge into the inner tank 6, a water supply orifice 8 fluidly connected to the inner tank 6, a first evacuation opening 9 through which separated coarse aggregates 10 are intended to be evacuated from the concrete recycler 5 and a second evacuation opening 11 through which water loaded with laitance and with fine aggregates is intended to be evacuated from the concrete recycler 5.

The coarse aggregates 10 evacuated from the concrete recycler 5 may for example fall by gravity onto the ground or into a coarse aggregate storage receptacle.

The concrete sludge treatment unit 3 also includes a sand module 12 comprising a hydrocyclone 13 including a cyclonic separation chamber 14, an inlet orifice 15 which opens into the cyclonic separation chamber 14 and which is fluidly connected to the second evacuation opening 11 of the concrete recycler 5, an upper evacuation orifice 16 which is provided in an upper portion of the hydrocyclone 13 and through which the water loaded with laitance is intended to be evacuated from the hydrocyclone 13, and a lower evacuation orifice 17 which is provided in a lower portion of the hydrocyclone 13 and through which water loaded with fine aggregate is intended to be evacuated from the hydrocyclone 13.

The sand module 12 further comprises a filter element 18, such as a vibrating grid, which is configured to filter the water loaded with fine aggregates evacuated from the hydrocyclone 13 so as to separate the fine aggregates from the water. Advantageously, the separated fine aggregates 19 are received in a fine aggregate collection receptacle 21. The water filtered by the filter element 18 can for example be recovered in a recovery vat 20, which is advantageously provided with a stirring element. The sand module 12 may also be provided with a supply pump making it possible to supply the hydrocyclone 13 with water loaded with laitance and fine aggregates from the concrete recycler 5, and possibly with water from the recovery vat 20.

The clarification and dewatering unit 4 includes in particular a stirring basin 22 in which the water loaded with laitance from the hydrocyclone 13 is intended to be conveyed and stirred, and a clarification and pressing device 23 configured to be supplied with water loaded with laitance from the stirring basin 22, for example using a supply pump.

According to the embodiment of the invention represented in the figures, the clarification and pressing device 23 is a vertical decantation silo which includes in particular a decantation chamber 24 configured to be supplied with water loaded with laitance, and a pressing chamber 25 located below the decantation chamber 24 and configured to receive the decanted laitance. The laitance is advantageously dewatered in the pressing chamber 25 by the pressure exerted by the column of water contained in the decantation chamber 24.

Advantageously, the vertical decantation silo includes an upper closing device comprising an upper closing element 26 which is movable between a closed position in which the upper closing element 26 isolates the decantation chamber 24 from the pressing chamber 25 and an open position in which the upper closing element 26 fluidly communicates the decantation chamber 24 and the pressing chamber 25, and a lower closing device comprising a lower closing element 27 which is movable between a closed position in which the lower closing element 27 isolates a lower portion of the pressing chamber 25 from the exterior of the vertical decantation silo and an opened position in which the lower closing element 27 allows an evacuation by gravity of the dewatered laitance 28, for example in the form of a disc, from the pressing chamber 25 and the vertical decantation silo.

The control of the displacements of the upper and lower closing elements 26, 27 can be carried out according to the flow rate of water flowing through a water outlet pipe 29 fluidly connected to the pressing chamber 25. For example, as long as the flow rate of water through the water outlet pipe 29 is higher than a predetermined flow rate value, the lower closing element 27 is held in its closed position and the upper closing element 26 is held in its opened position, and as soon as the flow rate of water through the water outlet pipe 29 becomes lower than the predetermined flow rate value, the upper closing element 26 is moved to its closed position then the lower closing element 27 is moved to its opened position in order to allow the evacuation of the dewatered laitance 28.

The concrete manufacturing plant 2 further comprises a storage basin 31 in which at least part of the clarified water coming from the clarification and pressing device 23 is intended to be conveyed and stored. Advantageously, the water supply orifice 8 of the concrete recycler 5 is fluidly connected to the storage basin 31 such that the washing water used by the concrete recycler 5 comes from the storage basin 31. Nonetheless, the water supply orifice 8 of the concrete recycler 5 could be fluidly connected to the stirring basin 22 such that the wash water used by the concrete recycler 5 comes from the stirring basin 22 and is loaded with laitance.

A method for recycling and recovering concrete sludge, which is partly implemented by the concrete manufacturing plant 2, will now be described. Such a recycling and recovering method comprises the following steps:
a concrete sludge treatment step successively including a first separation step consisting in separating coarse aggregates, contained in the concrete sludge and having dimensions larger than a first predetermined value, from water loaded with laitance and with fine aggregates which is contained in the concrete sludge, and a second separation step consisting in separating fine aggregates, contained in the water loaded with laitance and fine aggregates which has been separated during the first separation step and having dimensions larger than a second predetermined value, from water loaded with laitance, the second predetermined value being lower than the first predetermined value,
a clarification and dewatering step consisting in clarifying the water loaded with laitance which has been separated during the second separation step and in dewatering the laitance contained in said water loaded with laitance,
a first use step consisting in using the coarse aggregates and the separated fine aggregates as a raw material for manufacturing the concrete produced by the concrete manufacturing plant 2,
a second use step consisting in using at least part of the clarified water resulting from the clarification and dewatering step as a raw material for manufacturing the concrete produced by the concrete manufacturing plant 2, and
a third use step consisting in using the dewatered laitance as a raw material for manufacturing the cement in a cement plant.

According to an implementation of the recycling and recovering method, the first predetermined value is comprised between 300 and 700 μm, and advantageously between 400 and 600 μm, and is for example equal to approximately 500 μm, and the second predetermined value is comprised between 60 and 100 μm, and advantageously between 70 and 90 μm, and is for example equal to approximately 80 μm.

According to an implementation of the recycling and recovering method, the first separation step is carried out using the concrete recycler 5 and comprises the following steps:
an introduction step consisting in introducing concrete sludge into the inner tank 6 of the concrete recycler 5 via the introduction hopper 7 of the concrete recycler 5,
a step of washing the concrete sludge contained in the inner tank 6 with clarified water coming from the storage basin 31 and therefore resulting from the clarification and dewatering step,
a first evacuation step consisting in evacuating the water loaded with laitance and fine aggregates from the concrete recycler 5 via the second evacuation opening 11, and
a second evacuation step consisting in evacuating, for example by gravity, the separated coarse aggregates from the concrete recycler 5 via the first evacuation opening 9.

According to an implementation of the recycling and recovering method, the second separation step is carried out using the sand module 12 and comprises the following steps:
an introduction step consisting in introducing the water loaded with laitance and fine aggregates, which has been evacuated from the concrete recycler 5, into the hydrocyclone 13,
a first evacuation step consisting in evacuating the water loaded with laitance from the hydrocyclone 13 via the upper evacuation orifice 16 of the hydrocyclone 13,
a second evacuation step consisting in evacuating the water loaded with fine aggregates from the hydrocyclone 13 via the lower evacuation orifice 17 of the hydrocyclone,
a filtration step consisting in filtering the water loaded with fine aggregates using the filter element 18 so as to separate the fine aggregates from the water, and
a collection step consisting in receiving the separated fine aggregates 18 in the fine aggregate collection receptacle 21.

According to an implementation of the recycling and recovering method, the clarification and dewatering step comprises the following steps:
conveying, for example by gravity, the water loaded with laitance, which has been evacuated from the hydrocyclone 13, into the stirring basin 22,
stirring of the water laden with laitance contained in the stirring basin 22,
supplying the decantation chamber 24 of the vertical decantation silo with water loaded with laitance from the stirring tank 22,
decanting the water loaded with laitance in the decantation chamber 24,
dewatering the decanted laitance in the pressing chamber 25,
displacing the upper closing element 26 to its closed position and then displacing the lower closing element 27 to its opened position when the water flow rate through the water outlet pipe 29 becomes lower than the predetermined flow rate value, so as to drop by gravity the dewatered laitance 28 out of the vertical decantation silo,
displacing the lower closing element 27 to its closed position and then displacing the upper closing element 26 to its opened position,
successively repeating the decantation, dewatering and displacing steps so as to dewater all of the laitance contained in the decantation chamber 24, and
storing at least part of the water clarified by the vertical decantation silo in the storage basin 31.

According to an implementation of the recycling and recovering method, the latter further comprises a mixer truck washing step consisting in washing mixer trucks with water which has been clarified by the vertical decantation silo, and a cleaning step consisting in cleaning a mixing device of the concrete manufacturing plant 2 with water which has been clarified by the vertical decantation silo. To this end, the concrete manufacturing plant 2 advantageously comprises one or several washing station(s) 32 equipped with a washing pole 33 supplied with water coming from the storage basin 31. Thus, the mixer trucks and the mixing device of the concrete manufacturing plant 2 may be washed in a closed circuit. At least one washing station 32 could be located near the concrete recycler 5 or be integrated into the latter.

According to an implementation of the recycling and recovering method, the latter further includes concrete sludge screening step which is carried out prior to the concrete sludge treatment step and which consists in separating blocks of concrete, which have dimensions larger than a predetermined dimension, from concrete sludge. Such a screening step, which can be carried out using a screening bucket, avoids the introduction of large-sized concrete blocks into the concrete recycler 5. The predetermined dimension may be comprised between 10 and 30 mm, advantageously between 15 and 25 mm, and is for example equal to approximately 20 mm.

According to an implementation of the recycling and recovering method, the latter comprises a step of crushing the concrete blocks separated during the screening step, and a step of using the crushed concrete blocks for the building construction, such as buildings, road infrastructures or even urban developments of all types. These arrangements make it possible to further improve the recovering of concrete sludge.

According to an implementation of the recycling and recovering method, the latter also includes a collection step consisting in collecting concrete sludge from different concrete manufacturing plants. These arrangements make it possible to centralize the treatment of concrete sludge in the same concrete manufacturing plant, and therefore to limit the costs of treating this concrete sludge.

As goes without saying, the invention is not limited only to the implementations of this recycling and recovering method, described above as example, but in the contrary, it encompasses all variants thereof.

1. A method for recycling and recovering concrete sludge comprising the following steps:
a concrete sludge treatment step comprising separating aggregates, contained in the concrete sludge, from the water loaded with laitance contained in the concrete sludge;
a clarification and dewatering step comprising clarifying the water loaded with laitance which has been separated during the concrete sludge treatment step and in dewatering the laitance contained in the water loaded with laitance;
a first use step comprising using the separated aggregates as raw material for concrete manufacturing;
a second use step comprising using at least part of the clarified water resulting from the clarification and dewatering step as a raw material for the manufacture of concrete and
a third use step comprising using the dewatered laitance as a raw material for the manufacture of cement, and/or the step of clarification and dewatering being carried out using a vertical decantation silo including a decantation chamber configured to be supplied with water loaded with laitance, and a pressing chamber located below the decantation chamber and configured to receive the decanted laitance, the laitance being dewatered in the pressing chamber by the pressure exerted by the water column contained in the decantation chamber.

2. The recycling and recovering method according to claim 1, wherein the concrete sludge treatment step includes a first separation step consisting in separating coarse aggregates, contained in the concrete sludge and having dimensions larger than a first predetermined value, from the water loaded with laitance and fine aggregates which is contained in the concrete sludge, and a second separation step consisting in separating fine aggregates, contained in the water loaded with laitance and fine aggregates which has been separated during the first separation step and having dimensions larger than a second predetermined value, from the water loaded with laitance, the second predetermined value being lower than the first predetermined value.

3. The recycling and recovering method according to claim 2, wherein the first predetermined value is comprised between 300 and 700 μm.

4. The recycling and recovering method according to claim 2, wherein the second predetermined value is comprised between 60 and 100 μm.

5. The recycling and recovering method according to claim 2, wherein the first separation step comprises a step of washing the concrete sludge.

6. The recycling and recovering method according to claim 5, wherein the step of washing the concrete sludge is carried out with clarified water resulting from the clarification and dewatering step or with water loaded with laitance which has been separated during the concrete sludge treatment step.

7. The recycling and recovering method according to claim 2, wherein the first separation step is carried out using a concrete recycler.

8. The recycling and recovering method according to claim 2, wherein the second separation step is carried out at least partially by centrifugation.

9. The recycling and recovering method according to claim 1, wherein the clarification and dewatering step consists in decanting the water loaded with laitance which has been separated during the concrete sludge treatment step and in dewatering the decanted laitance.

10. The recycling and recovering method according to claim 1, which comprises a conveying step consisting in conveying the water loaded with laitance, which has been separated during the concrete sludge treatment step, in a stirring basin, and a stirring step consisting in stirring the water loaded with laitance contained in the stirring basin, the conveying and stirring steps being carried out prior to the clarification and dewatering step.

11. The recycling and recovering method according to claim 1, which comprises a storage step consisting in storing at least part of the clarified water resulting from the clarification and dewatering step in a storage basin.

12. The recycling and recovering method according to claim 1, which comprises a mixer truck washing step consisting in washing mixer trucks with clarified water resulting from the clarification and dewatering step or with water loaded with laitance resulting from the concrete sludge treatment step.

13. The recycling and recovering method according to claim 1, which comprises a cleaning step consisting in cleaning at least one mixing device of a concrete manufacturing plant with clarified water resulting from the clarification and dewatering step.

14. The recycling and recovering method according to claim 1, which further includes a concrete sludge screening step which is carried out prior to the concrete sludge treatment step and which consists in separating concrete blocks, which have dimensions larger than a predetermined dimension, from concrete sludge.

15. The recycling and recovering method according to claim 14, which comprises a step of crushing the separated concrete blocks.

16. The recycling and recovering method according to claim 1, which includes a collection step consisting in collecting concrete sludge from different concrete manufacturing plants.

17. The recycling and recovering method according to claim 3, wherein the second predetermined value is comprised between 60 and 100 μm.

18. The recycling and recovering method according to claim 17, wherein the first separation step comprises a step of washing the concrete sludge.

19. The recycling and recovering method according to claim 18, wherein the step of washing the concrete sludge is carried out with clarified water resulting from the clarification and dewatering step or with water loaded with laitance which has been separated during the concrete sludge treatment step.

20. The recycling and recovering method according to claim 19, wherein the first separation step is carried out using a concrete recycler.
